(19) United States
(12) Patent Application Publication
(10) Pub. No.: US 2017/0267167 A1
(43) Pub. Date: Sep. 21, 2017

(54) ROAD SURFACE ILLUMINATION APPARATUS

(71) Applicant: MITSUBISHI ELECTRIC CORPORATION, Tokyo (JP)

(72) Inventors: Reiko SAKATA, Tokyo (JP); Masato HIRAI, Tokyo (JP); Akiko IMAISHI, Tokyo (JP); Masami AIKAWA, Tokyo (JP); Kei KASUGA, Tokyo (JP); Hidebumi ARAI, Tokyo (JP); Yumiko OCHIAI, Tokyo (JP)

(73) Assignee: MITSUBISHI ELECTRIC CORPORATION, Tokyo (JP)

(21) Appl. No.: 15/504,974

(22) PCT Filed: Aug. 19, 2014
(86) PCT No.: PCT/JP2014/071655

§ 371 Date: Feb. 17, 2017

(51) Int. Cl. B60Q 1/54; B60Q 1/34; B60Q 1/24

(52) U.S. Cl. CPC B60Q 1/54; B60Q 1/24; B60Q 1/34; B60Q 1/503

(57) ABSTRACT

Because a road surface illumination apparatus is configured so as to include a vehicle state detector 3 configured to detect the traveling direction of a vehicle on the basis of vehicle information acquired by a vehicle information acquisition unit 2, and an illumination pattern selector 4 to select an illumination pattern expressing the traveling direction detected by the vehicle state detector 3 from among illumination patterns held therein and provided for traveling directions, and to cause an illumination device 7 to illuminate at least a road surface in a direction different from the traveling direction with the selected illumination pattern, the road surface illumination apparatus can provide a notification of the traveling direction of the vehicle intuitively to persons outside the vehicle who are existing in the direction other than the traveling direction.

### TECHNICAL FIELD

The present invention relates to a road surface illumination apparatus that illuminates a road surface around a vehicle with light.

### BACKGROUND ART

Patent Literatures 1 and 2 disclose methods of notifying pedestrians and so on of the state of a vehicle by illuminating a road surface with light in accordance with the driving state of the vehicle.

A safety device for moving objects disclosed in Patent Literature 1 calculates a traveling path along which the vehicle is assumed to travel and illuminates a road surface with a visible light beam indicating the traveling path, so as to notify other vehicles of the existence of the vehicle. The safety device for moving objects also acquires pieces of road surface projection information projected onto a road surface by using visible light beams with which the road surface is illuminated by the vehicle and other vehicles, and detects travel information about the vehicle and the other vehicles, to determine a state to which the vehicle should pay attention.

A road surface illumination apparatus disclosed in Patent Literature 2 illuminates a road surface under the front portion of the vehicle body and a road surface under the rear portion of the vehicle body with light, in synchronization with blink of the direction indicator light, in order to make use of a direction indication function without being affected by the influence of a glare phenomenon caused by the headlight or the like and without imposing restrictions on the design of the vehicle.

### CITATION LIST

### Patent Literature

Patent Literature 1: Japanese Patent Application Publication No. 2003-231450.

Patent Literature 2: Japanese Patent Application Publication No. Hei 11-301346.

### SUMMARY OF INVENTION

### Technical Problem

However, the problem with the devices disclosed in Patent Literatures 1 and 2 is that depending on a positional relationship between the vehicle and pedestrians or the likes, the pedestrians or the likes cannot grasp the vehicle state, such as the traveling direction and the speed of the vehicle, even if they look at light with which a road surface is illuminated from a direction other than the traveling direction of the vehicle. For example, according to Patent Literature 2, although the vehicle which is making a left turn illuminates road surfaces under front and rear portions on a left side of the vehicle body with light, there is a possibility that pedestrians or the likes cannot see the direction toward which the vehicle is turning because the illumination light cannot be easily seen even if the pedestrians or the likes try to see the illumination light from a rear right-hand side of the vehicle.

Further, there is a case in which the necessity to illuminate a road surface with light is low depending on the existence or non-existence of objects, such as pedestrians and other vehicles, in the surroundings of the vehicle. Irradiation of light at all times even when the necessity to illuminate a road surface with light is low is unpreferable from the viewpoint of the amount of electricity consumed, environmental considerations, etc., and, as a result, the whole town is full of illumination light.

The present invention is made in order to solve the above-mentioned problems, and it is therefore an object of the present invention to provide a technique for providing a notification of the traveling direction of a vehicle to persons outside the vehicle, especially to persons existing in directions other than the traveling direction.

### Solution to Problem

According to the present invention, there is provided a road surface illumination apparatus which includes: a vehicle information acquisition unit to acquire vehicle information from vehicle-mounted equipment mounted in a vehicle; a vehicle state detector configured to detect the traveling direction of the vehicle on the basis of the vehicle information acquired by the vehicle information acquisition unit; and an illumination pattern selector to select an illumination pattern expressing the traveling direction detected by the vehicle state detector from among illumination patterns held therein and provided for traveling directions, respectively, and configured to cause an illumination device mounted in the vehicle to illuminate at least a road surface in a direction different from the traveling direction with the selected illumination pattern.

### Advantageous Effects of Invention

Because the road surface illumination apparatus according to the present invention illuminates a road surface in a direction different from the traveling direction with the illumination pattern expressing the traveling direction, the road surface illumination apparatus can provide a notification of the traveling direction of the vehicle to persons outside the vehicle, especially to persons existing in the direction other than the traveling direction.

### BRIEF DESCRIPTION OF DRAWINGS

FIG. 1 is a block diagram showing the configuration of a road surface illumination apparatus according to a first embodiment of the present invention;

FIG. 2 is a flow chart showing the operation of the road surface illumination apparatus according to the first embodiment;

FIGS. 3A to 3C are diagrams showing an example of an illumination pattern for a stationary vehicle with which a road surface is illuminated by the road surface illumination apparatus according to the first embodiment;

FIGS. 4A to 4C are diagrams showing an example of an illumination pattern for forward movement with which a road surface is illuminated by the road surface illumination apparatus according to the first embodiment;

FIGS. 5A to 5C are diagrams showing an example of an illumination pattern for backward movement with which a road surface is illuminated by the road surface illumination apparatus according to the first embodiment;

FIGS. 6A and 6B are diagrams showing an example of an illumination pattern for right turn with which a road surface is illuminated by the road surface illumination apparatus according to the first embodiment;

FIGS. 7A and 7B are diagrams showing examples of changing the illumination range of the illumination pattern for forward movement depending upon a vehicle speed, and FIG. 7A shows an example during travel at a high speed and FIG. 7B shows an example during travel at a low speed;

FIGS. 8A and 8B are diagrams showing examples of changing the illumination range of the illumination pattern for right turn depending upon the vehicle speed, and FIG. 8A shows an example during travel at a high speed and FIG. 8B shows an example during traveling at a low speed;

FIG. 9 is a block diagram showing the configuration of a road surface illumination apparatus according to a second embodiment of the present invention;

FIG. 10 is a flow chart showing the operation of the road surface illumination apparatus according to the second embodiment;

FIGS. 11A to 11C are diagrams showing examples of changing the illumination range of an illumination pattern for a stationary vehicle in response to nearby objects;

FIGS. 12A to 12C are diagrams showing examples of changing the illumination range of an illumination pattern for forward movement in response to nearby objects; and

FIGS. 13A and 13B are diagrams showing an example of deforming the illumination range of an illumination pattern for right turn in response to nearby objects, and FIG. 13A shows the illumination pattern for right turn before deformation and FIG. 13B shows the illumination pattern for right turn after deformation.

### DESCRIPTION OF EMBODIMENTS

Hereafter, in order to explain this invention in greater detail, the preferred embodiments of the present invention will be described with reference to the accompanying drawings.

### First Embodiment

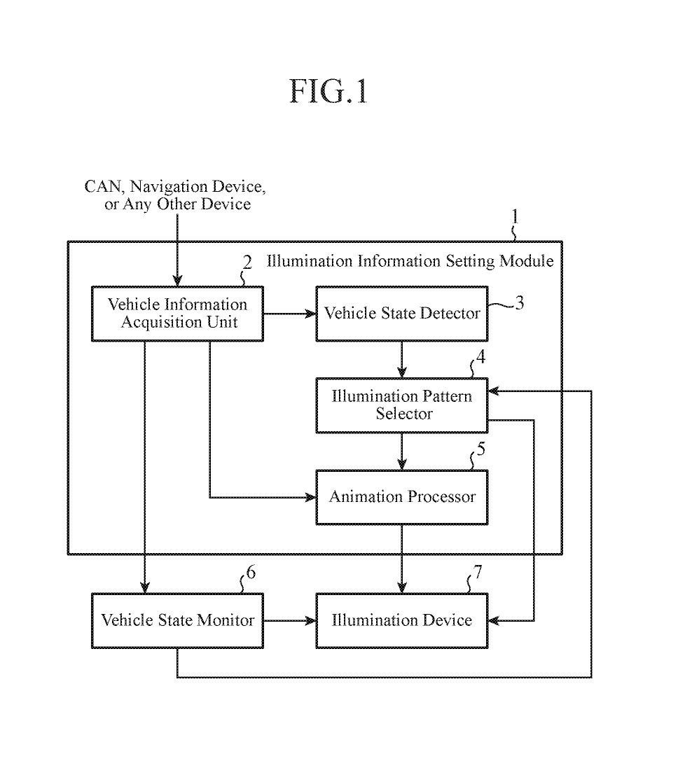

As shown in FIG. 1, a road surface illumination apparatus according to a first embodiment includes an illumination information setting module 1 and a vehicle state monitor 6, and illuminates an area around a vehicle with visible light from an illumination device 7 mounted in the vehicle. This road surface illumination apparatus is configured with a CPU (Central Processing Unit), a memory and so on, and performs the functions of the illumination information setting module 1 and the vehicle state monitor 6 by executing a program. The illumination device 7 is a laser or the like mounted in the vehicle, and illuminates an area under the vehicle and a road surface around the vehicle with visible light, to display a graphic or the like.

The illumination information setting module 1 includes a vehicle information acquisition unit 2, a vehicle state detector 3, an illumination pattern selector 4 and an animation processor 5.

The vehicle information acquisition unit 2 acquires vehicle information either from vehicle-mounted equipment via an in-vehicle network, such as a CAN (Controller Area Network), or directly from vehicle-mounted equipment. The vehicle information can include at least information from which whether the vehicle is either stationary or traveling can be determined, and information from which the traveling direction can be determined. For example, as the vehicle information, CAN data (information about operations such as operations on a blinker, a steering wheel, an accelerator, a brake, and a shift lever), or information outputted by a car navigation device is used.

The vehicle information acquisition unit 2 outputs the vehicle information acquired thereby to the vehicle state detector 3, the animation processor 5 and the vehicle state monitor 6.

The vehicle state detector 3 detect the vehicle state on the basis of the vehicle information received from the vehicle information acquisition unit 2, and outputs the vehicle state information to the illumination pattern selector 4. For example, the vehicle state information includes information showing whether the vehicle is either stationary or traveling, and information showing the traveling direction (forward movement, backward movement, right turn or left turn) at a time when the vehicle travels.

The illumination pattern selector 4 holds illumination patterns provided for vehicle states, and selects an illumination pattern from among the illumination patterns on the basis of the vehicle state information received from the vehicle state detector 3. For example, an illumination pattern for a stationary vehicle is provided for a time when the vehicle is stationary, and an illumination pattern for forward movement, an illumination pattern for backward movement, an illumination pattern for right turn, an illumination pattern for left turn, and so on are provided for a time when the vehicle travels. An illumination pattern is the graphic that clearly represents the directivity of the traveling direction, such as a line, a symbol or characters conforming to a general road traffic rule.

When the vehicle moves forward, the traveling direction is a forward direction, when the vehicle moves backward, the traveling direction is a backward direction, when the vehicle makes a right turn, the traveling direction is a rightward direction, and when the vehicle makes a left turn, the traveling direction is a leftward direction. Further, because the vehicle does not travel in any direction at a time when the vehicle is stationary, the traveling direction is all directions.

At a time when the vehicle is stationary, the illumination pattern selector 4 outputs the selected illumination pattern to the illumination device 7, whereas at a time when the vehicle travels, the illumination pattern selector 4 outputs the selected illumination pattern to the animation processor 5.

The animation processor 5 processes the illumination pattern received from the illumination pattern selector 4 on the basis of the vehicle information received from the vehicle information acquisition unit 2, to generate an animation, and outputs this animation to the illumination device 7. Although an example of processing the illumination pattern to generate an animation will be described below, the animation processor processes the illumination pattern to generate an animation emphasizing the traveling direction or an animation expressing the vehicle speed.

The vehicle state monitor 6 monitors the existence or non-existence of a change in the vehicle state on the basis of the vehicle information received from the vehicle information acquisition unit 2. The vehicle state mentioned here includes whether the vehicle is stationary or traveling, the traveling direction of the vehicle, and the speed of the vehicle. When there is no change in the vehicle state, the vehicle state monitor 6 instructs the illumination device 7 to continue illuminating without changing the illumination pattern, whereas when there is a change in the vehicle state, the vehicle state monitor 6 instructs the illumination device 7 to stop illuminating. When there is a change in the vehicle state, the vehicle state monitor 6 also instructs the illumination pattern selector 4 to re-select an illumination pattern.

The illumination device 7 illuminates a road surface with the illumination pattern received from either the illumination pattern selector 4 or the animation processor 5 of the illumination information setting module 1. Although a method of projecting laser light onto a road surface, or the like can be considered as a method of illuminating a road surface with the illumination pattern, this embodiment is limited to this method.

Next, the operation of the road surface illumination apparatus will be explained using a flow chart shown in FIG. 2. It is assumed that the vehicle information acquisition unit 2 performs an operation of acquiring the vehicle information from the vehicle and outputting the vehicle information to the vehicle state detector 3, the animation processing section 5 and the vehicle state monitor 6 at regular intervals, in parallel to the operation shown in the flow chart of FIG. 2.

The vehicle state detector 3, in step ST1, detects whether or not the vehicle is stationary on the basis of the vehicle information first. When the vehicle is stationary (when “YES” in step ST1), the vehicle state detector 3 outputs the vehicle state information showing that the vehicle is stationary to the illumination pattern selector 4. The illumination pattern selector 4 selects the illumination pattern for a stationary vehicle from among the plurality of illumination patterns on the basis of the vehicle state information received from the vehicle state detector 3, and outputs the illumination pattern for a stationary vehicle to the illumination device 7 (in step ST2).

When the vehicle is not stationary (when “NO” in step ST1), the vehicle state detector advances to step ST3.

The vehicle state detector 3, in step ST3, detects whether or not the vehicle is moving forward on the basis of the vehicle information. When the vehicle moves forward (when “YES” in step ST3), the vehicle state detector 3 outputs the vehicle state information showing that the vehicle is moving forward to the illumination pattern selector 4. The illumination pattern selector 4 selects the illumination pattern for forward movement from among the plurality of illumination patterns on the basis of the vehicle state information received from the vehicle state detector 3, and outputs the illumination pattern for forward movement to the animation processor 5 (in step ST4).

When the vehicle does not move forward (when “NO” in step ST3), the vehicle state detector advances to step ST5.

The vehicle state detector 3, in step ST5, detects whether or not the vehicle is moving backward on the basis of the vehicle information. When the vehicle moves backward (when “YES” in step ST5), the vehicle state detector 3 outputs the vehicle state information showing that the vehicle is moving backward to the illumination pattern selector 4. The illumination pattern selector 4 selects the illumination pattern for backward movement from among the plurality of illumination patterns on the basis of the vehicle state information received from the vehicle state detector 3, and outputs the illumination pattern for backward movement to the animation processor 5 (in step ST6).

When the vehicle does not move backward (when “NO” in step ST5), the vehicle state detector advances to step ST7.

The vehicle state detector 3, in step ST7, detects whether or not the vehicle is making a right or left turn on the basis of the vehicle information. When the vehicle makes a right or left turn (when “YES” in step ST7), the vehicle state detector 3 outputs the vehicle state information showing that the vehicle is making a right or left turn to the illumination pattern selector 4. The illumination pattern selector 4 selects the illumination pattern for right turn or the illumination pattern for left turn from among the plurality of illumination patterns on the basis of the vehicle state information received from the vehicle state detector 3, and outputs the illumination pattern for right turn or the illumination pattern for left turn to the animation processor 5 (in step ST8).

When the vehicle does not make a right or left turn (when “NO” in step ST7), the road surface illumination apparatus advances to step ST9.

The animation processor 5, in step ST9, determines a region which is to be processed to generate an animation and which is included in the illumination pattern received from the illumination pattern selector 4, on the basis of the traveling direction information included in the vehicle information received from the vehicle information acquisition unit 2. The animation processor 5 also varies the variation speed, the illumination range, etc. of the animation, on the basis of the vehicle speed information included in the vehicle information received from the vehicle information acquisition unit 2. For example, the full range of vehicle speeds is divided into a plurality of ranges, such as a slowly traveling range of under 20 km/h, a low-speed traveling range of 20 km/h to 40 km/h, a normal-speed traveling range of 40 km/h to 50 km/h, a middle-speed traveling range of 20 km/h to 40 km/h, and a high-speed traveling range of over 80 km/h, and the variation of the animation is speeded up to express the vehicle speed with increase in the vehicle speed. The animation processor 5 outputs the illumination pattern on which the animation processing is performed to the illumination device 7.

The illumination device 7, in step ST10, illuminates the road surface with either the illumination pattern for a stationary vehicle received from the illumination pattern selector 4, or the illumination pattern for forward movement, backward movement or right or left turn, which is received from the animation processor 5 and on which the animation processing is performed.

The vehicle state monitor 6, in step ST11, determines whether the vehicle state has changed on the basis of the vehicle information received from the vehicle information acquisition unit 2. When the vehicle state has changed, such as when the traveling direction has changed or the vehicle speed has varied (when “YES” in step ST11), the vehicle state monitor 6, in step ST12, instructs the illumination device 7 to stop illuminating, and also instructs the illumination pattern selector 4 to re-select an illumination pattern, and the road surface illumination apparatus returns to step ST1. When the vehicle state has not changed (when “NO” in step ST11), the road surface illumination apparatus returns to step ST10, and the vehicle state monitor 6 instructs the illumination device 7 to continue illuminating without changing the illumination pattern.

Next, the illumination patterns will be explained.

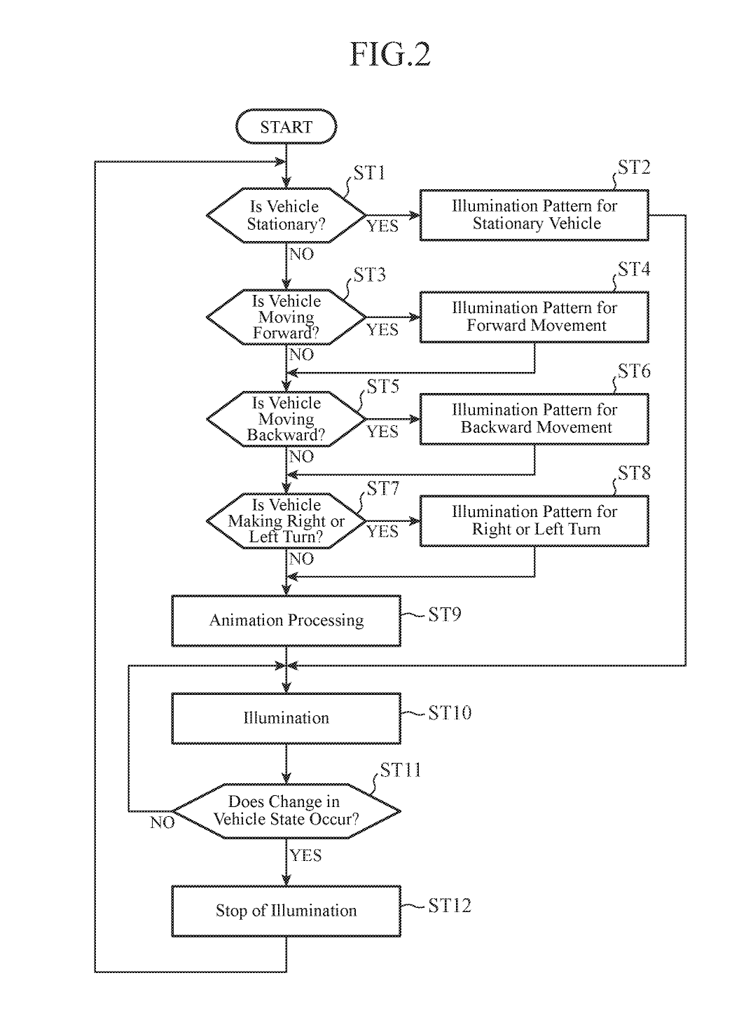

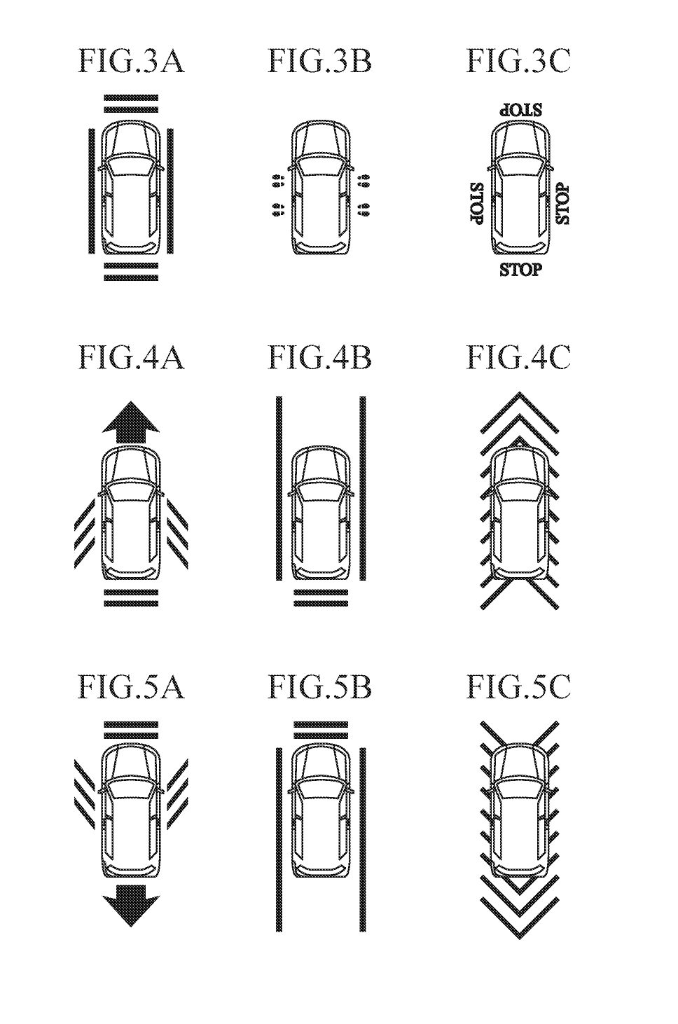

Examples of the illumination pattern for a stationary vehicle are shown in FIGS. 3A to 3C.

In traffic signs painted on the road, a solid line drawn on the road surface may mean that vehicles are forbidden from crossing the line and overtaking another vehicle. Therefore, in the example of FIG. 3A, the road surface illumination apparatus illuminates an area around the vehicle with the illumination pattern for a stationary vehicle which encloses the area around the vehicle with solid lines, to express the state in which the vehicle is stationary. Because the vehicle does not move in any direction at a time when the vehicle is stationary, the illumination pattern for a stationary vehicle is applied in all directions.

There is the possibility that a person gets out of the stationary vehicle. Therefore, in the example of FIG. 3B, the road surface illumination apparatus illuminates an area around the vehicle with the illumination pattern for a stationary vehicle which is shaped into footprints placed before the doors, to express the state in which the vehicle is stationary.

Further, in the example of FIG. 3C, the road surface illumination apparatus illuminates an area around the vehicle with the illumination pattern for a stationary vehicle in which icons or character strings, such as “STOP”, which make it possible to intuitively notice that the vehicle is stationary are disposed in the area around the vehicle, to express the state in which the vehicle is stationary. Also in these examples, because the illumination pattern for a stationary vehicle shows that the vehicle does not move in any direction, the illumination pattern for a stationary vehicle is applied in all directions.

Examples of the illumination pattern for forward movement are shown in FIGS. 4A to 4C.

In the example of FIG. 4A, the road surface illumination apparatus illuminates an area ahead of the vehicle (i.e., a road surface in the traveling direction of the vehicle) with an arrow pointing in the traveling direction, illuminates areas to the left and right of the vehicle (i.e., road surfaces in directions different from the traveling direction of the vehicle) with pairs of linearly symmetric oblique lines spreading out from the traveling direction to a direction opposite to the traveling direction, and illuminates an area behind the vehicle (i.e., a road surface in a direction different from the traveling direction of the vehicle) with solid lines meaning that vehicles are forbidden from crossing a traffic line and overtaking the vehicle. Further, the road surface illumination apparatus processes the front arrow to generate an animation in which the front arrow blinks, to emphasize the traveling direction. In addition, when the vehicle speed is high, the road surface illumination apparatus can increase the speed at which the arrow is blinking, whereas when the vehicle speed is low, the road surface illumination apparatus can decrease the speed at which the arrow is blinking, to express the vehicle speed.

In the example of FIG. 4B, the road surface illumination apparatus expresses the traveling direction by enclosing an area around the vehicle other than an area in the traveling direction of the vehicle, with the illumination pattern having solid lines meaning that vehicles are forbidden from crossing a traffic line and overtaking the vehicle. Further, the road surface illumination apparatus processes the illumination pattern to generate an animation in which the color or brightness of the solid lines to the left and right of the vehicle vary in a gradation manner along a direction from the rear to the front. In addition, the road surface illumination apparatus can vary the speed at which the gradation of the color or brightness varies depending upon the vehicle speed, to express the vehicle speed.

In the example of FIG. 4C, the road surface illumination apparatus illuminates an area around the vehicle with plural pairs of linearly symmetric oblique lines (a plurality of arrows) spreading out from the traveling direction to the direction opposite to the traveling direction, to express the traveling direction. Further, the road surface illumination apparatus processes the illumination pattern to generate an animation in which an arrow flows from the rear to the front. In addition, the road surface illumination apparatus can vary the speed at which an arrow flows depending upon the vehicle speed, to express the vehicle speed.

Examples of the illumination pattern for backward movement are shown in FIGS. 5A to 5C.

These examples of the illumination pattern for backward movement are the ones in which the examples of the illumination pattern for forward movement shown in FIGS. 4A to 4C are reversed back and forth. Further, when processing each of the examples of the illumination pattern to generate an animation, the road surface illumination apparatus blinks the arrow behind the vehicle in the example of FIG. 5A, varies the color or brightness of the solid lines to the left and right of the vehicle in a gradation manner along a direction from the front to the rear in the example of FIG. 5B, and causes an arrow to flow from the front to the rear in the example of FIG. 5C.

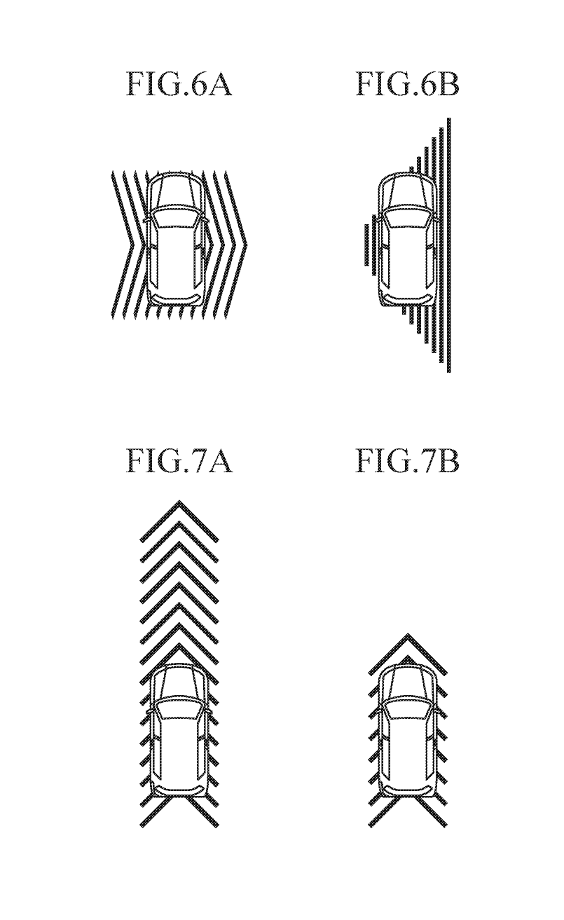

In the examples shown in FIGS. 5A and 5B, and 6A and 6B, the front, rear, left and right areas around the vehicle are illuminated with the different graphics, as explained above. As an alternative, the front, rear, left and right areas around the vehicle can be illuminated with an identical graphic. For example, each of the four areas including the front, rear, left and right areas around the vehicle is illuminated with an arrow pointing in the traveling direction.

Examples of the illumination pattern for right turn are shown in FIGS. 6A and 6B.

In the example of FIG. 6A, the road surface illumination apparatus illuminates an area around the vehicle with plural pairs of linearly symmetric oblique lines (a plurality of arrows) spreading out from the direction toward which the vehicle is turning to a direction opposite to the direction toward which the vehicle is turning, to express the direction toward which the vehicle is turning. Further, when the vehicle makes a right turn, the road surface illumination apparatus processes the illumination pattern to generate an animation in which an arrow flows from the left to the right, to emphasize the direction toward which the vehicle is turning. An example of the illumination pattern for left turn is one in which the illumination pattern shown in FIG. 6A is reversed left and right, and is processed to generate an animation in which an arrow flows from the right to the left. In addition, the road surface illumination apparatus can vary the speed at which an arrow flows, depending upon the vehicle speed, to express the vehicle speed.

In the example of FIG. 6B, the road surface illumination apparatus illuminates an area around the vehicle with a plurality of straight lines extending in the longitudinal directions of the vehicle, and having lengths becoming short along a direction from a side in the direction toward which the vehicle is turning to a side in the opposite direction, to express the vehicle speed. Further, when the vehicle makes a right turn, the road surface illumination apparatus processes the illumination pattern to generate an animation in which a straight line gets longer in the longitudinal directions of the vehicle while flowing from the left to the right, to emphasize the direction toward which the vehicle is turning. An example of the illumination pattern for left turn is one in which the illumination pattern shown in FIG. 6B is reversed left and right, and is processed to generate an animation in which a straight line gets longer in the longitudinal directions of the vehicle while flowing from the right to the left. In addition, the road surface illumination apparatus can vary the speed at which a straight line flows, depending upon the vehicle speed, to express the vehicle speed.

When the vehicle makes a right turn, a road surface to the right of the vehicle corresponds to a road surface in the traveling direction, and a road surface to the left of the vehicle corresponds to a road surface in the direction different from the traveling direction. When the vehicle makes a left turn, a road surface to the left of the vehicle corresponds to a road surface in the traveling direction, and a road surface to the right of the vehicle corresponds to a road surface in the direction different from the traveling direction.

Next, examples of processing an illumination pattern to generate an animation depending upon the vehicle speed will be explained.

FIGS. 7A and 7B show examples of changing the illumination range of the illumination pattern for forward movement depending upon the vehicle speed, and FIG. 7A shows an example of the illumination range set while the vehicle is traveling at a high speed and FIG. 7B shows an example of the illumination range set while the vehicle is traveling at a low speed. While the vehicle is moving forward, when the vehicle speed is high, the road surface illumination apparatus widens the illumination range extending in the longitudinal directions of the illumination pattern of the animation in which an arrow pointing to an area ahead of the vehicle flows from the rear to the front, whereas when the vehicle speed is low, the road surface illumination apparatus narrows the illumination range.

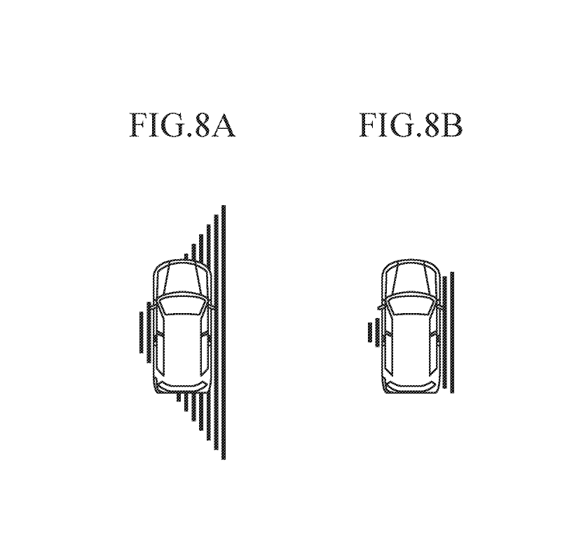

FIGS. 8A and 8B show examples of changing the illumination range of the illumination pattern for right turn depending upon the vehicle speed, and FIG. 8A shows an example of the illumination range set while the vehicle is traveling at a high speed and FIG. 8B shows an example of the illumination range set while the vehicle is traveling at a low speed. While the vehicle is making a right turn, when the vehicle speed is high, the road surface illumination apparatus widens the illumination range extending in the longitudinal directions of the illumination pattern expressed by the plurality of straight lines, whereas when the vehicle speed is low, the road surface illumination apparatus narrows the illumination range.

Although in the above-mentioned example the configuration in which the animation processor 5 processes an illumination pattern to generate an animation is explained, the animation processing performed by the animation processor 5 (in step ST9 of FIG. 2) can be eliminated.

As mentioned above, because the road surface illumination apparatus according to the first embodiment is configured so as to include: the vehicle information acquisition unit 2 to acquire the vehicle information from vehicle-mounted equipment mounted in the vehicle; the vehicle state detector 3 to determine the traveling direction of the vehicle on the basis of the vehicle information acquired by the vehicle information acquisition unit 2; and the illumination pattern selector 4 to select an illumination pattern expressing the traveling direction detected by the vehicle state detector 3 from among the illumination patterns held therein and provided for traveling directions, and to cause the illumination device 7 to illuminate at least a road surface in a direction different from the traveling direction with the selected illumination pattern, the road surface illumination apparatus can provide a notification of the traveling direction of the vehicle to persons outside the vehicle, especially to persons existing in the direction other than the traveling direction. As a result, persons outside the vehicle can notice that the vehicle is approaching theretoward or the vehicle is not approaching theretoward, from the illumination pattern with which the road surface is illuminated.

Further, because the road surface illumination apparatus according to the first embodiment is configured so as to include the animation processor 5 to process the illumination pattern selected by the illumination pattern selector 4 to generate an animation varying toward the traveling direction of the vehicle, the road surface illumination apparatus can provide a notification of the traveling direction of the vehicle to persons outside the vehicle more intelligibly.

Further, because the animation processor 5 according to the first embodiment is configured so as to, when the vehicle speed is high, widen the illumination range of the illumination pattern depending upon the vehicle speed included in the vehicle information acquired by the vehicle information acquisition unit 2, whereas when the vehicle speed is low, narrow the illumination range, the road surface illumination apparatus can provide a notification of the speed of the vehicle to persons outside the vehicle intelligibly.

Further, because the animation processor 5 according to the first embodiment is configured so as to, when the vehicle speed is high, increase the variation speed of the illumination pattern depending upon the vehicle speed included in the vehicle information acquired by the vehicle information acquisition unit 2, whereas when the vehicle speed is low, decrease the variation speed of the illumination pattern, the road surface illumination apparatus can provide a notification of the speed of the vehicle to persons outside the vehicle intelligibly.

Further, because the illumination pattern selector 4 according to the first embodiment is configured so as to illuminate a road surface in the traveling direction of the vehicle, in addition to a road surface in the direction different from the traveling direction of the vehicle, with the illumination pattern, the road surface illumination apparatus can provide a notification of the traveling direction of the vehicle to persons outside the vehicle.

### Second Embodiment

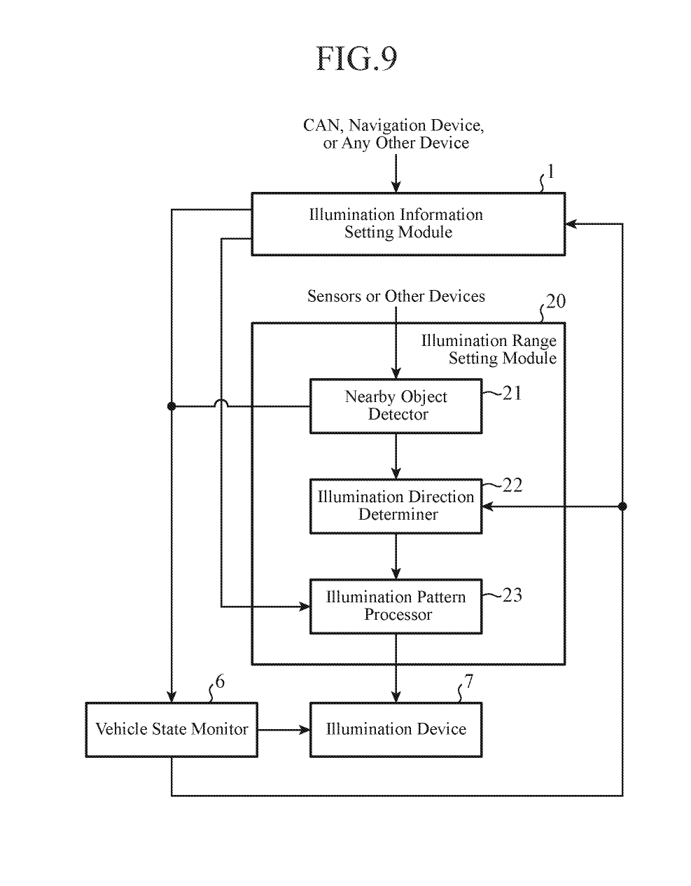

FIG. 9 is a block diagram showing an example of the configuration of a road surface illumination apparatus according to the second embodiment. In FIG. 9, the same components as those of FIG. 1 or like components are designated by the same reference numerals, and the explanation of the components will be omitted hereafter. The road surface illumination apparatus according to the second embodiment is configured so as to additionally include an illumination range setting module 20.

The illumination range setting module 20 includes a nearby object detector 21, an illumination direction determiner 22 and an illumination pattern processor 23.

The nearby object detector 21 acquires sensing information from sensors mounted in a vehicle, and detects the positions of pedestrians, other vehicles, etc. (referred to as nearby objects from here on) existing in an area around the vehicle. As a sensing method, there is a method of detecting the direction of and the distance to each nearby object, and information showing what each nearby object is (e.g., a walking person, a standing person, a child or a vehicle), by using either a silhouette included in an image captured by the imaging sensor of a camera or the existence or non-existence of an object detected by a photosensor using an LED light source.

The nearby object detector 21 outputs the nearby object information acquired thereby to the illumination direction determiner 22 and a vehicle state monitor 6.

The illumination direction determiner 22 determines both a direction for which there is a necessity to apply an illumination pattern and a direction for which the necessity to apply an illumination pattern is low, on the basis of the nearby object information received from the nearby object detector 21, and outputs the illumination direction information to the illumination pattern processor 23.

The illumination pattern processor 23 receives an illumination pattern from an illumination information setting module 1, and processes the illumination pattern on the basis of the illumination direction information received from the illumination direction determiner 22. As a method of illuminating an area in the direction having a low necessity to apply the illumination pattern, there can be provided a method of reducing the illumination range of the illumination pattern, a method of eliminating the illumination range, a method of blurring and shading off the illumination pattern, or a method of switching to illumination with invisible light which is not visible. The illumination pattern processor 23 outputs the illumination pattern processed thereby to an illumination device 7.

The vehicle state monitor 6 monitors the existence or non-existence of a change in the vehicle state on the basis of the vehicle information received from the illumination information setting module 1 and the nearby object information received from the nearby object detector 21 of the illumination range setting module 20. The vehicle state mentioned here includes whether the vehicle is stationary or traveling, the traveling direction of the vehicle, the speed of the vehicle, and the positions of the nearby objects. When there is no change in the vehicle state, the vehicle state monitor 6 instructs the illumination device 7 to continue illuminating without changing the illumination pattern, whereas when there is a change in the vehicle state, the vehicle state monitor 6 instructs the illumination device 7 to stop illuminating. When there is a change in the vehicle state, the vehicle state monitor 6 also instructs an illumination pattern selector 4 to re-select an illumination pattern, and instructs the illumination direction determiner 22 to perform the determination of the illumination directions again.

The illumination device 7 illuminates a road surface with the illumination pattern received from the illumination pattern processor 23 of the illumination range setting module 20. When reducing the illumination range, instead of the method of processing data about the illumination pattern in the illumination pattern processor 23, a method of mechanically reducing the illumination range of visible light by reducing the projected area of laser light in the illumination device 7 can be alternatively provided.

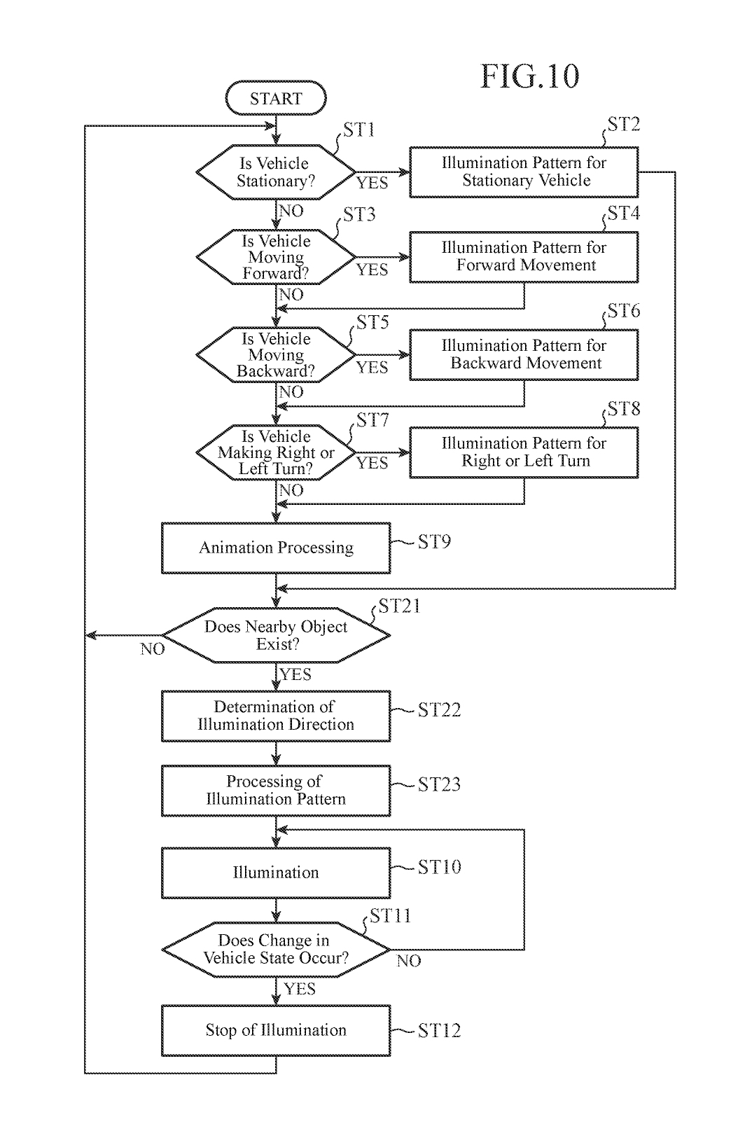

Next, the operation of the road surface illumination apparatus will be explained using a flow chart shown in FIG. 10. It is assumed that a vehicle information acquisition unit 2 performs an operation of acquiring the vehicle information from the vehicle and outputting the vehicle information to a vehicle state detector 3, an animation processor 5 and the vehicle state monitor 6 at regular intervals, and the nearby object detector 21 performs an operation of acquiring the sensing information from the sensors at regular intervals, in parallel with the operation shown in the flowchart of FIG. 10. Because processes in steps ST1 to ST9 and ST12 of FIG. 10 are the same as those shown in FIG. 2, the explanation of the processes will be omitted hereafter.

The nearby object detector 21, in step ST21, determines whether a nearby object exists in the surroundings of the vehicle, on the basis of the sensing information. When a nearby object exists (when “YES” in step ST21), the nearby object detector 21 outputs the nearby object information to the illumination direction determiner 22 and the vehicle state monitor 6, and the road surface illumination apparatus advances to step ST22.

When no nearby object exists (when “NO” in step ST21), the road surface illumination apparatus does not illuminate an area around the vehicle with an illumination pattern because the necessity to provide the notification of the state of the vehicle to the surroundings of the vehicle is low, and then returns to step ST1.

The illumination direction determiner 22, in step ST22, determines the illumination direction of the illumination pattern on the basis of the nearby object information received from the nearby object detector 21, and outputs the illumination direction information to the illumination pattern processor 23. For example, when the nearby object is a parked vehicle, the illumination direction determiner determines that the necessity to apply an illumination pattern in the direction of the nearby object is low. When the nearby object is a traveling vehicle or a person, the illumination direction determiner determines that the necessity to apply an illumination pattern in the direction of the nearby object is high, but the necessity to apply an illumination pattern in any other direction is low.

The illumination pattern processor 23, in step ST23, processes the illumination range of the illumination pattern received from the illumination information setting module 1 on the basis of the illumination direction information received from the illumination direction determiner 22, and outputs the illumination pattern to the illumination device 7. The illumination device 7, in step ST10, illuminates a road surface with the illumination pattern received from the illumination pattern processor 23. When the vehicle state monitor 6, in step ST11, determines that the nearby object or the vehicle state has changed, the road surface illumination apparatus stops illuminating (in step ST12) and returns to step ST1.

Next, examples of processing the illumination range of the illumination pattern in response to nearby objects will be explained.

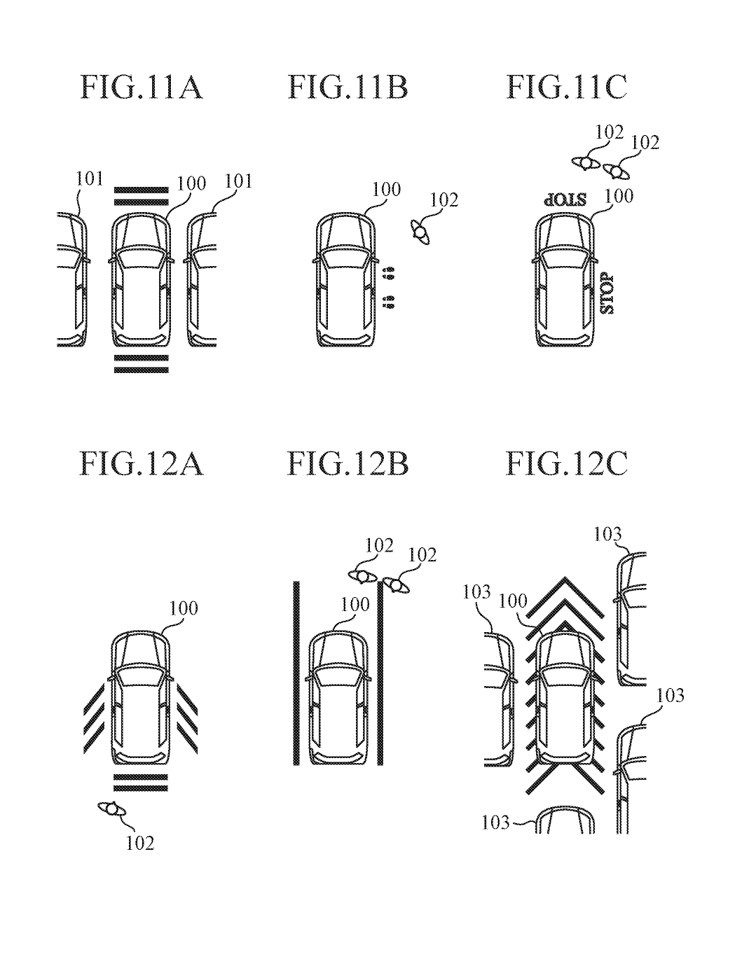

Examples of changing the illumination range of the illumination pattern for a stationary vehicle in response to nearby objects are shown in FIGS. 11A to 11C.

In the example of FIG. 11A, because parked vehicles 101 are existing to both the left and right of the vehicle 100, the road surface illumination apparatus illuminates only areas ahead of and behind the vehicle, which are not obscured by the parked vehicles 101, with an illumination pattern for a stationary vehicle.

In the example of FIG. 11B, because a person 102 is existing to the right of the vehicle 100, the road surface illumination apparatus illuminates an area in the direction of the person with an illumination pattern for a stationary vehicle, thereby notifying the person that the vehicle is stationary. When the illumination range setting module 20 can acquire information showing the opening or closing of a door from a door sensor or the like of the vehicle, the road surface illumination apparatus can illuminate a road surface in front of the door which will be opened with a footprint-like illumination pattern for a stationary vehicle, thereby notifying the person that the door will be opened.

In the example of FIG. 11C, because persons 102 are existing in a right front area in the vicinity of the vehicle 100, the road surface illumination apparatus illuminates an area in the direction of the persons with an illumination pattern for a stationary vehicle.

Examples of deforming the illumination range of an illumination pattern for forward movement in response to nearby objects are shown in FIGS. 12A to 12C.

In the example of FIG. 12A, because a person 102 is existing behind the vehicle 100 which is moving forward, the road surface illumination apparatus illuminates an area behind the vehicle with an illumination pattern for forward movement, thereby notifying the person 102 that the vehicle 100 will not move in the direction toward the person 102.

In the example of FIG. 12B, because persons 102 are existing ahead of the vehicle 100 which is moving forward, the road surface illumination apparatus illuminates areas on both sides of the vehicle, which are visible from an area ahead of the vehicle, with an illumination pattern for forward movement, thereby notifying the persons 102 that the vehicle 100 will move in the direction toward the persons 102.

In the example of FIG. 12C, a plurality of traveling vehicles 103 are existing in the surroundings of the vehicle 100 which is moving forward, the road surface illumination apparatus illuminates an area around the vehicle 100 with an illumination pattern for forward movement, thereby making it possible for the illumination pattern be visible from every direction.

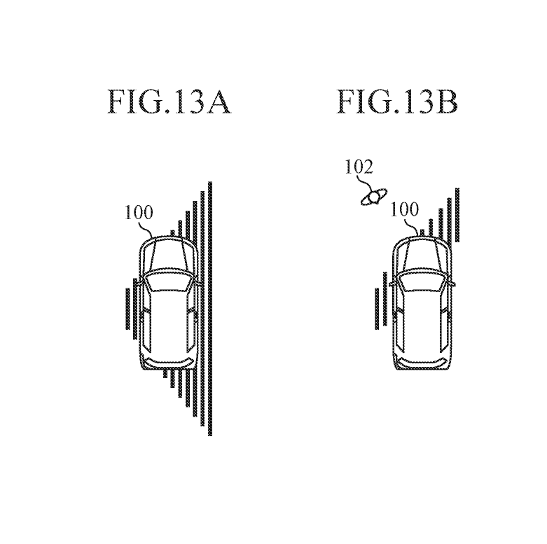

An example of deforming the illumination range of an illumination pattern for right turn in response to nearby objects is shown in FIGS. 13A and 13B. FIG. 13A shows an example of the illumination pattern for right turn before deformation, and FIG. 13B shows an example of the illumination pattern for right turn after deformation. When a person 102 exists ahead of the vehicle 100, the road surface illumination apparatus illuminates only an area ahead of the vehicle in the vicinity of which the person 102 is existing with an illumination pattern for right turn, as shown in FIG. 13B, thereby notifying the person that the vehicle 100 is making a right turn. At this time, while the illumination pattern for right turn of FIG. 13A expresses a right turn by using an animation in which two or more straight lines get longer in the longitudinal directions of the vehicle while flowing from the left to the right, the illumination pattern for right turn of FIG. 13B expresses a right turn by using an animation in which two or more straight lines move toward the area ahead of the vehicle in the vicinity of which the person 102 is existing while flowing from the left to the right. By using this method, the intention expressed by the animation is notified even if the illumination range is deformed.

As mentioned above, the road surface illumination apparatus according to the second embodiment is configured so as to include the illumination range setting module 20 to set the direction in which the illumination pattern selected by the illumination pattern selector 4 of the illumination information setting module 1 is applied, in response to the nearby object information showing the existence or non-existence and the direction of a nearby object existing in an area around the vehicle. Because the road surface illumination apparatus does not apply the illumination pattern in directions for which the necessity to apply the illumination pattern is low, the road surface illumination apparatus can prevent the whole town from being full of illumination light. Further, the road surface illumination apparatus can take the amount of electricity consumed and environments into consideration.

While the present invention has been described in its preferred embodiments, it is to be understood that an arbitrary combination of two or more of the above-mentioned embodiments can be made, various changes can be made in an arbitrary component according to any one of the above-mentioned embodiments, and an arbitrary component according to any one of the above-mentioned embodiments can be omitted within the scope of the invention.

### INDUSTRIAL APPLICABILITY

Because the road surface illumination apparatus according to the present invention illuminates a road surface in a direction different from the traveling direction with an illumination pattern expressing the traveling direction, the road surface illumination apparatus is suitable for use as a road surface illumination apparatus or the like that notifies the movement of the vehicle to others outside the vehicle.

### REFERENCE SIGNS LIST

1: illumination information setting module, 2: vehicle information acquisition unit, 3: vehicle state detector, 4: illumination pattern selector, 5: animation processor, 6: vehicle state monitor, 7: illumination device, 20: illumination range setting module, 21: nearby object detector, 22: illumination direction determiner, 23: illumination pattern processor, 100: vehicle, 100: parked vehicle, 102: person, and 103: traveling vehicle.

1. A road surface illumination apparatus comprising:
a nearby object detector to detect a position of a person existing in an area around a vehicle; and
an illumination pattern selector to select an illumination pattern to be expressed from among illumination patterns held therein, and to control illumination to a road surface to illuminate an area where an existence of the person is detected by the nearby object detector and not to illuminate an area where an existence of the person is not detected by the nearby object detector.

2. The road surface illumination apparatus according to claim 1, comprising:
a vehicle information acquisition unit to acquire vehicle information from vehicle-mounted equipment mounted in said vehicle;
a vehicle state detector to detect a traveling direction of said vehicle on a basis of the vehicle information acquired by said vehicle information acquisition unit; and
an animation processor to process the illumination pattern selected by said illumination pattern selector to generate an animation varying toward the traveling direction of said vehicle.

3. The road surface illumination apparatus according to claim 1, wherein, depending upon a vehicle speed included in the vehicle information acquired by said vehicle information acquisition unit, said animation processor widens an illumination range of the illumination pattern when the vehicle speed is high, whereas said animation processor narrows the illumination range of the illumination pattern when the vehicle speed is low.

4. The road surface illumination apparatus according to claim 2, wherein, depending upon a vehicle speed included in the vehicle information acquired by said vehicle information acquisition unit, said animation processor increases a speed of variation of the illumination pattern when the vehicle speed is high, whereas said animation processor decreases the speed of variation when the vehicle speed is low.

5-6. (canceled)

7. The road surface illumination apparatus according to claim 1, wherein said illumination pattern selector changes the selected illumination pattern depending upon a direction in which the person is detected by said nearby object detector.

8. A road surface illumination method comprising:
detecting a position of a person existing in an area around a vehicle;
selecting an illumination pattern to be expressed from among illumination patterns held therein; and
controlling illumination to a road surface to illuminate an area where an existence of the person is detected, and not to illuminate an area where an existence of the person is not detected.
